(19) United States
(12) Patent Application Publication
(10) Pub. No.: US 2007/0159104 A1
(43) Pub. Date: Jul. 12, 2007

(54) Metal halide lamp and luminaire using the same

(76) Inventors: Yukiya Kanazawa, Osaka (JP); Atsushi Utsubo, Osaka (JP); Hiroshi Nohara, Hyogo (JP); Shunsuke Kakisaka, Osaka (JP); Yoshiharu Nishiura, Shiga (JP)

Correspondence Address: SNELL & WILMER L.L.P. (Matsushita), 600 ANTON BOULEVARD, SUITE 1400, COSTA MESA, CA, 92626, US

(21) Appl. No.: 10/582,737

(22) PCT Filed: Dec. 20, 2004
(86) PCT No.: PCT/JP04/19484

§ 371 Date: Jun. 13, 2006

(30) Foreign Application Priority Data
Dec. 22, 2003 (JP) 2003-424170

(51) Int. Cl. H01J 61/30; H01J 17/16

(52) U.S. Cl. 313/634

(57) ABSTRACT

The present invention aims at providing a metal halide lamp that (i) prevents a decline in the lumen maintenance and a deterioration of quality in appearance due to the coloring of a casing tube surrounding the arc tube, and at the same time (ii) achieves high luminous efficiency. A metal halide lamp (1) has a pair of electrodes (20a&b) placed in an arc tube (3) made of translucent ceramic, and a sodium halide is enclosed therein. The metal halide lamp (1) satisfies L/D 4, where L (mm) is the length of the space between the electrodes (20a&b) and D (mm) is the internal diameter of the arc tube (3). The metal halide lamp (1) has a casing tube (2) surrounding the arc tube (3), at least around a portion between the electrodes (20a&b). Here, R/r 3.0 is satisfied, where R is the internal diameter of the casing tube (2) and r is the external diameter of the arc tube (3), within a region positionally corresponding to, in a radial direction of the arc tube, the space between the electrodes (20a&b), on a cross-sectional surface where an outer circumference of the arc tube (3) comes closest to the internal circumference of the casing tube (2).

### CROSS-REFERENCE TO RELATED APPLICATIONS

This application is based on application No. 2003-424170 filed in Japan, the contents of which are hereby incorporated by reference.

### TECHNICAL FIELD

The present invention relates to a metal halide lamp, and a luminaire using the same.

### BACKGROUND ART

As to metal halide lamps used with luminaires for, for instance, outdoor lighting and high ceiling lighting, recent years an improvement in luminous efficiency has been strongly desired from the aspect of energy saving.

In response to such a demand, a certain type of ceramic metal halide lamps has been proposed (see, e.g. Published Japanese translation of a PCT application No. 2000-501563). In a ceramic metal halide lamp of this type, translucent ceramic that withstands a high bulb wall loading, namely withstands use at a high temperature, is used as a material for the envelope of the arc tube. Such translucent ceramic is, for example, made of alumina. The arc tube has an elongated shape (L/D>5, when the internal diameter of the arc tube is D and the length of the space (i.e. distance) between the electrodes is L), and cerium iodide (CeI₃) and sodium iodide (NaI) are enclosed therein.

It is said that this ceramic metal halide lamp is capable of achieving extremely high luminous efficiency of 111 lm/W-177 lm/W.

A type of ceramic metal halide lamps as described in the above-mentioned reference (Published Japanese translation of a PCT application No. 2000-501563) were manufactured by the present inventors as a trial and examined regarding the lighting performance. This examination revealed unexpected issues. In the examination, within a short lighting period of 500 hours, the internal surface of the hard-glass outer tube where the arc tube was housed was colored brown. This was especially prominent around a section close to the discharge space of the arc tube. Along with a decline in the lumen maintenance, the quality in appearance was also deteriorated. Note that a quartz-glass sleeve may be disposed between the outer tube and the arc tube in order to provide protection from explosion. In this case, the examination found that the internal surface of the sleeve was colored brown in the same manner as it happened to the outer tube.

### DISCLOSURE OF THE INVENTION

The present invention was made in order to solve these new issues that did not occur with a conventional ceramic metal halide lamp. The first objective of the present invention is to provide a metal halide lamp having the following characteristics: (i) to prevent a decline in the lumen maintenance as well as a deterioration of quality in appearance which arise as a result of the coloring caused in a casing tube (e.g. an outer tube and a sleeve) surrounding the arc tube, and at the same time (ii) to achieve high luminous efficiency.

The second objective of the present invention is to provide a luminaire that uses such a metal halide lamp and obtains the same characteristics mentioned above, namely, (i) to prevent a decline in the lumen maintenance as well as a deterioration of quality in appearance which arise as a result of the coloring of the casing tubes, and at the same time (ii) to achieve high luminous efficiency.

With an analysis of the colored section in the outer tube or the sleeve, the inventors found that aluminum, magnesium, and such were deposited on the internal surfaces of the outer tube or the sleeve. The aluminum was a component of the ceramic (alumina) forming the envelope of the arc tube, and the magnesium was an additive agent of the ceramic. Namely, it has been found that the ceramic, which is a material of the envelope of the arc tube, was evaporated and dispersed inside the outer tube or the sleeve, and was subsequently deposited on the internal surfaces of these casing tubes. The coloring was caused by the deposited substance.

The ceramic is used for the envelope because it is a material that is supposed to withstand use at a high temperature. Nonetheless, the above phenomenon occurred, and this is thought to be attributable to the arc tube made in an elongated shape (e.g. L/D>5) in order to achieve high luminous efficiency. As a result, an arc of the metal halide lamp was formed close to the internal surface of the arc tube during illumination, and then the temperature of the ceramic reached a far greater than expected value. Consequently, even the heat-resisting ceramic was evaporated and dispersed.

After conducting a further analysis and advancing an investigation into this point, the inventors found that the phenomenon in which the ceramic is evaporated and dispersed could occur not only when L/D>5, but also when a relational expression of L/D≧4 is satisfied.

The present invention was made based on such newly obtained knowledge, and has the following configuration.

In order to achieve the first objective above, the metal halide lamp of the present invention comprises: an arc tube having an envelope made of translucent ceramic, a pair of electrodes disposed therein, and one or more halides are enclosed therein; and a casing tube surrounding at least a portion of the arc tube. The portion of the arc tube positionally corresponds to, in a radial direction of the arc tube, a space between the electrodes. Here, L/D≧4, where L is a length of the space between the electrodes and D is an internal diameter of the arc tube. R/r≧3.0, where R is an internal diameter of the casing tube and r is an external diameter of the arc tube, within a region positionally corresponding to, in the radial direction, the space between the electrodes, on a cross-sectional surface where an outer circumference of the arc tube comes closest to an inner circumference of the casing tube.

Note that the “internal diameter of the arc tube” phrased in this specification can be found in the following way: 1) in the arc tube, locate a portion across the region positionally corresponding to the space between the electrodes, and find the internal surface area of this portion; and 2) divide this internal surface area by the length of the space between the electrodes. If the shape of the internal surface is complex, a cumbersome procedure may be required in order to find an averaged value for the internal diameter (D).

The “portion of the arc tube positionally corresponding to, in a radial direction of the arc tube, a space between the electrodes” means, in other words, a portion of the arc tube sandwiched by two imaginary planes. Each of the imaginary planes lies at a tip of one of the electrodes, and is perpendicular to a central axis in a longitudinal direction of the electrode.

The “casing tube” indicates a tubular member placed closest to the arc tube and longitudinally surrounding the arc tube, at least around a portion sandwiched by the two imaginary planes. For instance, in the case where the arc tube is housed in an outer tube and there is no other tubular member, e.g. a sleeve, placed between the arc tube and the outer tube, the “casing tube” is the outer tube. On the other hand, in the case where the arc tube is housed in an outer tube but a sleeve for providing protection from explosion is placed between the arc tube and the outer tube, the “casing tube” is the sleeve. In the case in which there is yet another tubular member placed between the arc tube and the sleeve, the “casing tube” is this tubular member. It is desirable that the casing tube be made of a translucent and heat-resisting material. One example of such is quartz glass, however, the material shall be selected case by case based on, for example, the use conditions of the metal halide lamp.

According to the above configuration, a decline in the lumen maintenance and a deterioration of quality in appearance due to the coloring caused in the casing tube can be prevented while high luminous efficiency is achieved.

As with the above metal halide lamp, R/r may be no smaller than 4.7 and no larger than 8.0.

According to the above configuration, the coloring of the internal surface of the casing tube in particular is further prevented. As a result, a decline in the lumen maintenance and a deterioration of quality in appearance can be further prevented. In addition, the configuration does not sacrifice the compatibility of the metal halide lamp with existing commercially available luminaires.

As with the above metal halide lamp, L/D may be no smaller than 4 and no larger than 10.

The above configurations allow for achieving high luminous efficiency as well as facilitating the maintenance of the discharge.

Furthermore, as with the above metal halide lamp, the arc tube may be disposed in a hermetically-sealed space. The degree of vacuum in the space is no more than 1×10³ Pa at 300 K.

The above configurations allow for preventing a decline in the luminous efficiency.

As with the above metal halide lamp, one ore more oxygen-releasing getters may be disposed in the space.

The above configurations allow for preventing the coloring of the internal surface of the casing tube as well as achieving high luminous efficiency. Accordingly, a decline in the lumen maintenance and a deterioration of quality in appearance caused by the coloring can be prevented. Moreover, the lumen maintenance can be improved.

Furthermore, as with the above metal halide lamp, the halides may include sodium.

In order to achieve the second objective mentioned above, the luminaire of the present invention comprises: a metal halide lamp recited in one of Claims 1 to 10 of the present invention; and a lighting circuit for illuminating the metal halide lamp.

According to the above configuration, a decline in the lumen maintenance and a deterioration of quality in appearance due to the coloring caused in the casing tube can be prevented while high luminous efficiency is achieved.

### BRIEF DESCRIPTION OF THE DRAWINGS

FIG. 1 is a front view of a metal halide lamp according to a first embodiment of the present invention, with a part cut away to reveal the internal arrangements;

FIG. 2 is a front cross-sectional view of an arc tube used in the metal halide lamp;

FIG. 3 shows results of experiments conducted in order to determine the operational effectiveness of the metal halide lamp;

FIG. 4 shows the relationship between R/r and the maximum temperature T of an external surface of the arc tube;

FIG. 5 shows luminous efficiency and an occurrence of burnt-out lamps that were examined by using metal halide lamps with each having a different length of the space between a pair of electrodes;

FIG. 6 is a front view of a metal halide lamp according to a second embodiment of the present invention, with a part cut away to reveal the internal arrangements;

FIG. 7 shows lumen maintenance of metal halide lamps with and without oxygen-releasing getters.

FIG. 8 is a front view of a metal halide lamp according to a third embodiment of the present invention, with a part cut away to reveal the internal arrangements; and

FIG. 9 is a front view of a luminaire according to a fourth embodiment of the present invention, with a part cut away to reveal the internal arrangements.

### BEST MODES OF CARRYING OUT THE INVENTION

The following will describe the best modes for carrying out the present invention, with reference to the drawings.

### 1. First Embodiment

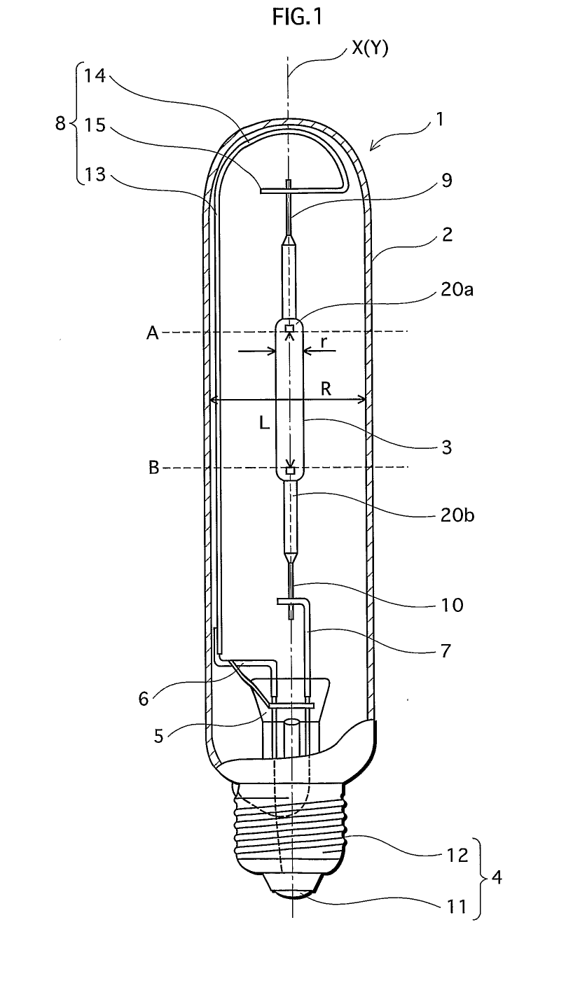

FIG. 1 shows a metal halide lamp (a ceramic metal halide lamp) 1 according to a first embodiment of the present invention. The metal halide lamp 1 with rated lamp wattage of 150 W has an overall length of 175 mm-185 mm (e.g. 180 mm). The metal halide lamp 1 comprises a casing tube 2, an arc tube 3, and a base 4. The casing tube 2 is an outer tube of the metal halide lamp 1, and the arc tube 3 is placed in the casing tube 2. The base 4 is a screw base (Edison screw base) fixed at an end of the casing tube 2. Note that the central axis (X in FIG. 1) in the longitudinal direction of the arc tube 3 substantially coincides with the central axis (Y in FIG. 1) in the longitudinal direction of the casing tube 2.

The casing tube 2 is a cylindrical tube made of, for example, hard glass or borosilicate glass. One end of the casing tube 2 is closed and round in shape, and the other end is closed by fixing thereto a flare 5 made of, for example, borosilicate glass. The inside of the casing tube 2 (the hermetically sealed space in which the arc tube 3 is placed) is kept in vacuum at a pressure of 1×10¹ Pa or lower (e.g. 1×10⁻¹ Pa) at 300 K.

When the degree of vacuum inside the casing tube 2 is specified as no more than 1×10¹ Pa at 300 K, the heat of the arc tube 3 is harder to be transferred to the casing tube 2 (i.e. the outer tube of the metal halide lamp 1) through the gas in the sealed space of the casing tube 2. As a result, the heat released to the outside of the metal halide lamp 1 is reduced, and therefore a decline in the luminous efficiency due to the heat loss is avoided.

On the other hand, when the degree of vacuum inside the casing tube 2 exceeds 1×10¹ Pa at 300 K, the heat of the arc tube 3 is more easily transferred to the casing tube 2 through the gas. As a result, the heat tends to be released to the outside of the metal halide lamp 1, and therefore there is a chance that the luminous efficiency will decline due to the heat loss.

Furthermore, it has been also found that the luminous efficiency significantly declines when the degree of vacuum exceeds 1×10² Pa at 300 K. Accordingly, in order to prevent a significant decline in the luminous efficiency, it is desirable that the degree of vacuum inside the casing tube 2 be specified to be no more than 1×10² Pa at 300 K. It is further desirable that the degree of vacuum be specified to be no more than 1×10¹ Pa at 300 K.

Two stem wires 6 and 7 are made of, for example, nickel or mild steel, and a portion of each the stem wires 6 and 7 is fixed onto the flare 5. One ends of the respective stem wires 6 and 7 are led into the inside of the casing tube 2. One stem wire 6 of the two is electrically connected, via an electric power supply wire 8, to an external lead wire 9, which is one of two external lead wires 9 and 10 (to be hereinafter described) led out from the arc tube 3. The other stem wire 7 is directly and electrically connected to the other external lead wire 10.

Within the casing tube 2, the arc tube 3 is supported by the two stem wires 6 and 7 and the electric power supply wire 8. The other end of the stem wire 6 is electrically connected to an eyelet 11 of the base 4, while the other end of the stem wire 7 is electrically connected to a shell 12 of the base 4.

Each of the stem wires 6 and 7 is a single metal wire formed by welding together a plurality of metal wires. The electric power supply wire 8 is made of a single metal wire composed of a first linear portion 13, a round arch portion 14, and a second linear portion 15. The first linear portion 13 runs straight, following the shape of the internal surface of the casing tube 2, from the proximity of the flare 5 toward the rounded closed end of the casing tube 2. The round arch portion 14 starts from the end of the first linear portion 13 and forms a substantially semicircular shape following the internal surface of the rounded closed end. The round arch portion 14 ends where another straight portion, i.e. the second linear portion 15, starts. The second linear portion 15 intersects the external lead wire 9 substantially perpendicularly.

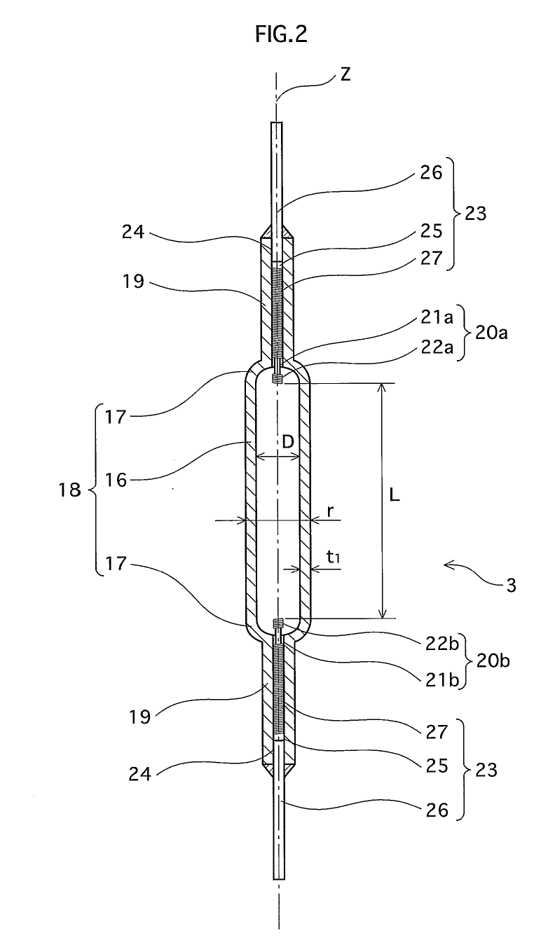

As shown in FIG. 2, the arc tube 3 has a polycrystalline alumina envelope composed of a main tube part 18 and two thin tube parts 19. The main tube part 18 is made up of a circular cylinder 16 and two rounded ends 17. Each of the rounded ends 17 is formed on each side of the circular cylinder 16. The thin tube parts 19 are each joined onto the rounded ends 17.

The metal halide lamp 1 satisfies a relational expression of R/r≧3.0, where R is the internal diameter of the casing tube 2 and r is the external diameter of the arc tube 3 (refer to FIG. 1), within a region positionally corresponding to, in the radial direction, the space between a pair of electrodes 20a and 20b (to be hereinafter described), on a cross-sectional surface where the outer circumference of the arc tube 3 comes closest to the inner circumference of the casing tube 2.

The “region positionally corresponding to, in a radial direction of the arc tube, the space between a pair of electrodes 20a and 20b” means a region sandwiched by two imaginary planes. FIG. 1 illustrates the two imaginary planes indicated with dashed lines A and B. The plane with the dashed line A lies at the tip of the electrode 20a and is perpendicular to the central axis in the longitudinal direction of the electrode 20a. Similarly, the plane with the dashed line B lies at the tip of the other electrode 20b and is perpendicular to the central axis in the longitudinal direction of the electrode 20b.

In the example depicted in FIGS. 1 and 2, “where the outer circumference of the arc tube 3 comes closest to the inner circumference of the casing tube 2” indicates individual portions of the arc tube 3 and the casing tube 2 sandwiched by the two imaginary planes. The portion of the arc tube 3 has a cylindrical shape with a uniform cross-sectional outer diameter. Similarly, the portion of the casing tube 2 has a cylindrical shape with a uniform cross-sectional inner diameter. In other words, “where the outer circumference of the arc tube 3 comes closest to the inner circumference of the casing tube 2” here coincides the entire extent where the external surface of the arc tube's cylindrical portion faces the internal surface of the casing tube's cylindrical portion.

The arc tube 3 is formed so as to satisfy a relational expression of L/D≧4, where D is the internal diameter of, within the main tube part 18, a portion sandwiched by the two imaginary planes. Here, the bulb wall loading (input lamp power per unit internal surface area of an arc tube) is set at 28 W/cm²-35 W/cm².

Note here that the following has become clear. When the internal diameter D of the arc tube 3 is smaller than 4.0 mm, the distance between the center of the arc and the internal surface of the arc tube 3 becomes significantly small. Herewith, the recombination of electrons in the discharge space becomes activated, and then the discharge becomes harder to be maintained. This may lead to burning out the metal halide lamp. Accordingly, it is preferable to set the internal diameter D of the arc tube 3 at 4.0 mm or larger in order to facilitate the maintenance of the discharge and prevent the metal halide lamp from burning out.

It is also preferable to set the wall thickness t₁ of the arc tube 3 at, at least, 1.2 mm or larger in order to maintain the mechanical strength of the arc tube 3. Therefore, in the case when the internal diameter D of the arc tube 3 is set at or more than the above specified value of 4.0 mm, it is desirable to specify the external diameter r of the arc tube 3 to be 6.4 mm or larger given the wall thickness t₁.

In the example shown in FIG. 2, respective components making up the envelope of the arc tube 3 are integrally formed in one piece with no joints. However, the envelope formed by integrating the respective components may be used instead. Such an envelope is formed by, for example, joining the thin tube parts 19 with the rounded ends 17 of the main tube part 18 by shrink-fit process.

As for the materials used to form the envelope of the arc tube 3, other kinds of translucent ceramics, such as yttrium aluminum garnet (YAG), aluminum nitride, yttria, and zirconia, can be used besides polycrystalline alumina.

In the arc tube 3, metal halides composed of praseodymium iodide (PrI₃) and sodium iodide (NaI), mercury, and a xenon gas (Xe) are enclosed. The metal halides are enclosed in the arc tube 3 in a manner that the mole ratio between PrI₃ and NaI becomes 1:10. The total amount of the metal halides enclosed is 5.5 mg-19 mg (e.g. 9 mg).

As to the mercury, an amount, e.g. 0.5 mg, is enclosed with which the lamp voltage falls into the range of 80 V-95 V when the metal halide lamp 1 is lit under rated conditions. The xenon gas is enclosed to be 20 kPa at 300 K.

In the main tube part 18, a pair of electrodes 20a and 20b is placed substantially opposite one another on the approximately same axis (Z in FIG. 2), and the discharge space is formed therein.

The electrode 20a has an electrode shaft 21a and an electrode coil 22a. Similarly, the other electrode 20b has an electrode shaft 21b and an electrode coil 22b. The electrode shafts 21a and 21b are 0.5 mm in diameter and made of tungsten. The electrode coils 22a and 22b are also made of tungsten, and are mounted on the tips of the electrode shafts 21a and 21b, respectively.

An electrode lead-in unit 23, to which one of the electrodes 20a and 20b is electrically connected at one end, is inserted in each of the thin tube parts 19. The electrode lead-in units 23 are fixed by glass frit 24 poured from the other ends of the thin tube parts 19 (each located further from the main tube part 18) into the spaces left between the inside of the thin tube parts 19 and the electrode lead-in units 23 inserted therein.

Each electrode lead-in unit 23 is composed of an internal lead wire 25, an external lead wire 26, and a coil 27. The internal lead wire 25 is made, for example, of molybdenum, and is connected to the electrode shaft 21a or 21b. The external lead wire 26 is made, for example, of niobium. The coil 27 is made of molybdenum, and is wound around a part of the electrode shaft 21a or 21b as well as a part of the internal lead wire 25.

One ends of the external lead wires 26 are each electrically connected to the internal lead wires 25. The other ends are led to the outside of the thin tube parts 19, and are electrically connected to the stem wire 7 and the electric power supply wire 8, respectively. The coil 27 substantially fills spaces left between part of the electrode shaft 21a or 21b and the internal lead wire 25, and thereby prevents the enclosed metal halides from seeping into the spaces.

Note that an electrode lead-in unit made of known materials or having a known structure can be used instead of the electrode lead-in unit 23 comprising the molybdenum internal lead wire 25, the niobium external lead wire 26, and the molybdenum coil 27.

The following explains experiments conducted in order to determine the operational effectiveness of the metal halide lamp 1 according to the first embodiment of the present invention.

1.1 Relationship Between R/r and Lumen Maintenance

The relationship between R/r and the lumen maintenance along with the coloring in the casing tube 2 was examined.

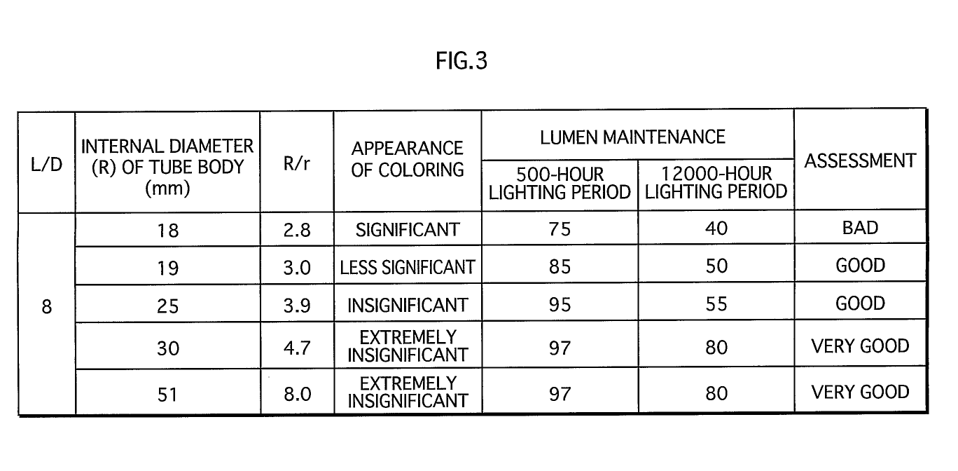

A plurality of the metal halide lamps 1 above were prepared as follows: the external diameter r of the arc tubes 3 was set at a constant of 6.4 mm but the internal diameter R of the casing tube 2 was changed in stages, ranging from 18 mm to 51 mm. Each of the prepared lamps was lit with the central axis of the lamp being horizontal (hereinafter simply ‘lit in the horizontal position’) using a publicly-known lighting circuit (for instance, one having an electronic ballast). Then, when a 500-hour lighting period elapsed, the appearance of the coloring in the casing tube 2 was checked with eyes, and the lumen maintenance (%) was examined. The lumen maintenance (%) was also examined after a 12000-hour lighting period. The results of these examinations are shown in FIG. 3. As to all the prepared lamps, the internal diameter D of the arc tube 3 was a constant of 4 mm, and the length L of the space between the electrodes 20a and 20b was a constant of 32 mm. Namely, these lamps satisfied a relational expression of L/D=8.

The lumen maintenance (%) is a proportion of the lamp's light output (lm) produced after a set time (here, 500 hours or 12000 hours) to the light output of the lamp after a 100-lighting period. In terms of an assessment criterion for the lumen maintenance, it was thought that the lamps were practically acceptable if the lumen maintenance after a 500-hour lighting period was no less than 85% and the lumen maintenance after a 12000-hour lighting period was no less than 50%. This criterion was adopted based on market demands.

As is clear from FIG. 3, when the internal diameter R of the casing tube 2 is 19 mm or larger (e.g. 19 mm, 25 mm, 30 mm, and 51 mm), or in other words, when a relational expression of R/r≧3.0 was satisfied, the coloring of the internal surface of the casing tube 2 was not significant. Furthermore, the lumen maintenance after a 500-hour lighting period and after a 12000-hour lighting period was no less than 85% and 50%, respectively, and thus the results satisfied the above assessment criterion.

Especially when the internal diameter R of the casing tube 2 was no less than 30 mm (e.g. 30 mm and 51 mm), or in other words, when a relational expression of R/r≧4.7 was satisfied, the coloring of the internal surface of the casing tube 2 was extremely insignificant. Furthermore, the lumen maintenance after a 500-hour lighting period and after a 12000-hour was 97% and 80%, respectively, and thus these results sufficiently exceeded the above assessment criterion.

The reasons why such results were obtained are considered as follows. The lamps satisfied the relational expression of L/D=8, and therefore the arc tube 3 was heated to a fairly high temperature since the arc was formed close to the internal surface of the arc tube 3. However, because ample space was provided between the casing tube 2 and the arc tube 3 across the region sandwiched by the imaginary planes, a thermal insulation effect of the casing tube 2 exerted on the arc tube 3 was reduced. As a result, the maximum temperature T (K) of the external surface of the arc tube 3 did not reach a temperature at which the ceramic forming the envelope of the arc tube 3 would heavily evaporate and disperse.

On the other hand, when the internal diameter R of the casing tube 2 was, for example, 18 mm, or in other words, when a relational expression of R/r<3.0 was satisfied, the coloring of the internal surface of the casing tube 2 became significant. The lumen maintenance after a 500-hour lighting period and after a 12000-hour was 75% and 40%, respectively, and thus the result failed to satisfy the above assessment criterion.

The reasons why such a result was obtained are considered as follows. The lamps satisfied the relational expression of L/D=8, and therefore the arc tube 3 was heated to a fairly high temperature since the arc was formed close to the internal surface of the arc tube 3. In addition, because restricted space was provided between the casing tube 2 and the arc tube 3 across the region sandwiched by the imaginary planes, the thermal insulation effect of the casing tube 2 exerted on the arc tube 3 increased. As a result, the maximum temperature T (K) of the external surface of the arc tube 3 reached the temperature at which the ceramic would heavily evaporate and disperse.

1.2 Relationship Between R/r and Maximum Temperature T

Next, the relationship between R/r and the maximum temperature T (K) of the external surface of the arc tube 3 was examined.

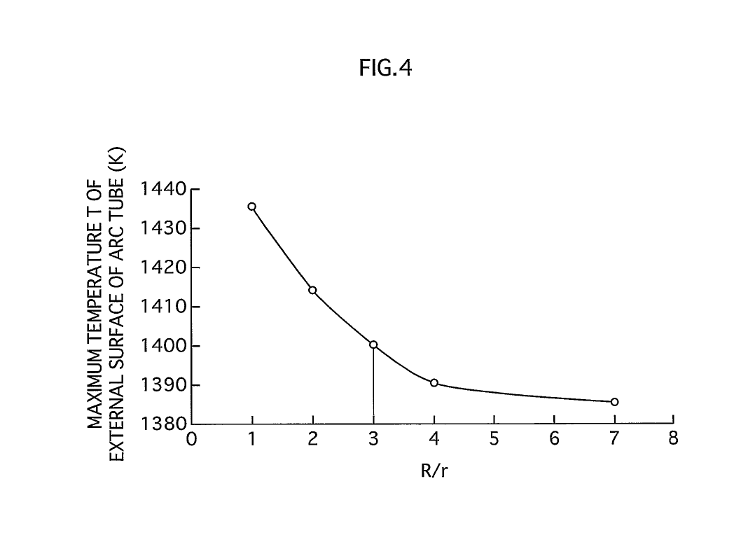

A plurality of the metal halide lamps 1 above were prepared as follows: the external diameter r of the arc tubes 3 was set at a constant of 6.4 mm but R/r was changed in stages, ranging from 1 to 7. Each of the prepared lamps was lit in the horizontal position using the lighting circuit. Then, the maximum temperature T (K) of the external surface of the arc tube 3 under steady state illumination conditions was measured. The results are shown in FIG. 4.

As to all the prepared lamps, the internal diameter D of the arc tube 3 was a constant of 4 mm, and the length L of the space between the electrodes 20a and 20b was a constant of 32 mm. Namely, these lamps satisfied the relational expression of L/D=8.

When the lamps are lit in the horizontal position, within the external surface of the arc tube 3, a point having the maximum temperature is found in the central portion on the upward side. This is because, when the lamps are lit in the horizontal position, the arc has an upward curvature by buoyancy and comes closest to the central portion on the upward side of the internal surface of the arc tube 3. A measurement of the temperature was conducted using a platinum-platinum-rhodium thermocouple fixed firmly onto the external surface of the central portion with cement made of talc.

As is clear from FIG. 4, it was found that the maximum temperature T of the external surface of the arc tube 3 reached 1400 K when R/r=3.0.

As described above, the followings were confirmed. When R/r≧3.0, a relational expression of T≦1400 K is satisfied. In this case, the coloring of the internal surface of the casing tube 2 can be prevented, and a decline in the lumen maintenance and a deterioration of quality in appearance due to the coloring can also be prevented.

The above results show that, in order to further prevent the coloring of the internal surface of the casing tube 2 and accordingly further prevent a decline in the lumen maintenance and a deterioration of quality in appearance due to the coloring, it is desirable that a relational expression of R/r≧4.0 be satisfied.

Note that it was also confirmed that the above results could be obtained not only when L/D=8. In fact, as long as a relational expression of L/D≧4 is satisfied, the value of L/D does not have influence on achieving these results.

Here, when a relational expression of R/r>8.0 is satisfied, the external diameter of the lamp becomes large. Accordingly, there is a possibility of lowering the compatibility of the lamp with existing commercially available luminaires. As a result, it is desirable that a relational expression of R/r≦8.0 be satisfied.

1.3 Relationship of Length L with Luminous Efficiency and Occurrence of Burnt-Out Lamps

The relationship of the length L of the space between the electrodes 20a and 20b with the luminous efficiency and the occurrence of burnt-out lamps was examined.

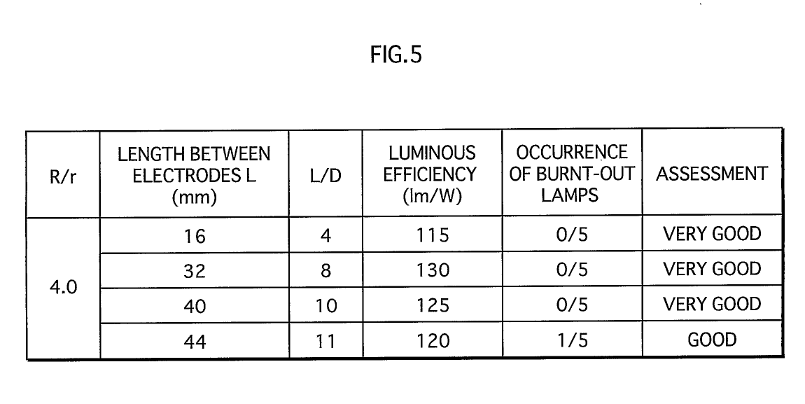

A plurality of the metal halide lamps 1 above were prepared as follows: the internal diameter D of the arc tube 3 was set at a constant of 4 mm but L/D was variously changed by altering the length L of the space between a pair of the electrodes 20a and 20b in stages, ranging from 16 mm to 44 mm. Thus, multiple classes, each having a different L/D value, were set up, and five lamps were prepared for each class. Each of the prepared lamps was lit in the horizontal position using the lighting circuit. Then, the luminous efficiency (lm/W) and the occurrence of burnt-out lamps after a 100-lighting period were examined. The results are shown in FIG. 5.

Note that r was 6.4 mm and R/r was 4.0.

As to “OCCURRENCE OF BURNT-OUT LAMPS” in FIG. 5, the denominator indicates the total number of lamps examined for a corresponding class while the numerator indicates the number of lamps, out of the total number of the examined lamps, burnt out after a 100-lighting period.

As is clear from FIG. 5, in the cases of L/D=4, 8, 10, and 11 where a relational expression of L/D≧4 was satisfied, the luminous efficiency after a 100-lighting period was 115 lm/W or higher. This is an approximately 28% or more improvement in luminous efficiency compared to a commercially available common ceramic metal halide lamp (90 lm/W-95 lm/W) with high efficiency and high color rendering.

The reasons why such results were obtained are considered as follows. The self-absorption ratio of sodium was reduced, and thereby emission in a wavelength range positively contributing to the luminous efficiency increased. Compared to a conventional lamp, the temperature of the internal surface of the arc tube 3 reached higher, and accordingly the vapor pressures of the metal halides were increased.

However, in the case of L/D=11 where a relational expression of L/D>10 was satisfied, one lamp out of five burned out although high luminous efficiency was obtained. This is thought because the length L of the space between the electrodes 20a and 20b was too long and therefore the discharge became harder to be maintained. As a result, it is desirable that a relational expression of L/D≦10 be satisfied in order to achieve high luminous efficiency as well as facilitate the maintenance of the discharge.

The above experiment examined the luminous efficiency by using a fixed R/r value of 4.0 and changing the value of L/D variously. However, this numerical setting was just an example, and it was confirmed that, regardless of the value of R/r, high luminous efficiency can be achieved as long as the relational expression of L/D≧4 is satisfied.

With the above configuration of the metal halide lamp 1 according to the first embodiment, especially because the relational expression of L/D≧4 is satisfied, the self-absorption ratio of sodium is reduced and thereby emission in the wavelength range positively contributing to the luminous efficiency can be increased. Furthermore, high luminous efficiency can be achieved since the vapor pressures of the metal halides are elevated by raising the temperature of the internal surface of the arc tube 3. On the other hand, ample space is provided between the casing tube 2 and the arc tube 3 across the region sandwiched by the imaginary planes (i.e. the region positionally corresponding to, in a radial direction of the arc tube, the space between the electrodes 20a and 20b), and thereby the thermal insulation effect of the casing tube 2 exerted on the arc tube 3 is reduced. Accordingly, it can be prevented that the maximum temperature T (K) of the external surface of the arc tube 3 will rise excessively high. This allows for preventing the ceramic forming the envelope of the arc tube 3 from heavily evaporating and dispersing. Consequently, this further prevents the internal surface of the casing tube 2 from being colored by the dispersed ceramic, and therefore a decline in the lumen maintenance as well as a deterioration of quality in appearance, which arise as a result of the coloring, can be prevented.

### 2. Second Embodiment

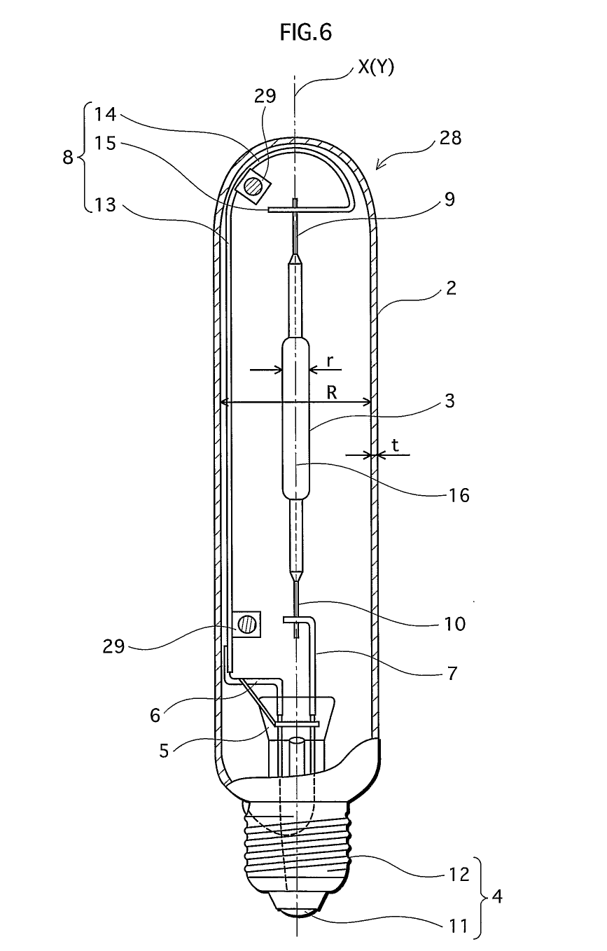

FIG. 6 shows a metal halide lamp (a ceramic metal halide lamp) 28 according to a second embodiment of the present invention. Besides having two oxygen-releasing getters 29, the metal halide lamp 28 with rated lamp wattage of 150 W has the same configuration as the metal halide lamp 1, having rated lamp wattage of 150 W, of the first embodiment. The two oxygen-releasing getters 29 are attached onto the electric power supply wire 8, with one placed nearer the rounded closed end of the casing tube 2 and the other positioned nearer the flare 5.

Note that L/D is 8, and R/r is 3.0.

The constituent of the oxygen-releasing getters 29 is barium peroxide (BaO₂). The oxygen-releasing getters 29 trap gas impurities in the casing tube 2 as well as release oxygen therein.

The pressure of the inside of the casing tube 2 was 1×10⁻¹ Pa at 300 K before the oxygen-releasing getters 29 released oxygen. After oxygen was released, the pressure increased to 1×10¹ Pa at 300 K.

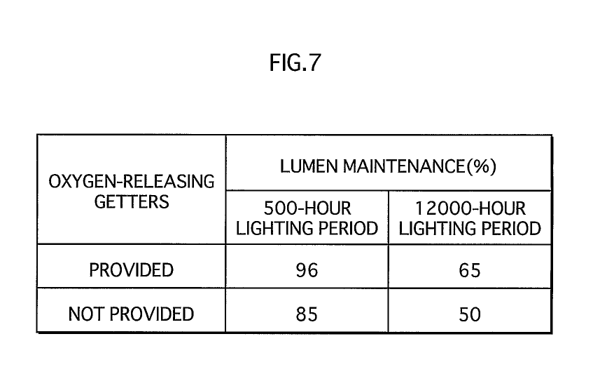

By using a plurality of the metal halide lamps 28 according to the second embodiment, the lumen maintenance (%) after a 500-hour lighting period and a 12000-hour lighting period was examined. Here, each of the metal halide lamps 28 was lit in the horizontal position using a publicly-known lighting circuit. The results are shown in FIG. 7.

With the purpose of comparison, FIG. 7 also shows the lumen maintenance obtained when the oxygen-releasing getters were not provided, based on the results shown in FIG. 3.

As is clear from FIG. 7, when the oxygen-releasing getters were provided, the lumen maintenance after a 500-hour lighting period and a 12000-hour lighting period was 96% and 65%, respectively. Thus, compared to the case with no oxygen-releasing getters provided, the lumen maintenance for the 500-hour lighting period increased by 13% and the lumen maintenance for the 12000-hour lighting period increased by 30%.

The improved results above are thought to be relevant to the phenomenon in which the dispersion of the alumina ceramic forming the envelope of the arc tube 3 significantly intensifies when the surface region of the ceramic envelope contains oxygen vacancies. That is, the present inventors reasoned as follows: Besides the fact that aluminum oxide (AlO) has a higher vapor pressure than alumina (Al₂O₃), the oxygen-releasing getters 29 were employed to release minute amount of oxygen into the casing tube 2. Herewith, the released oxygen was supplied to AlO at the oxygen vacancies. As a result, the AlO was chemically transformed to Al₂O₃, and consequently, the oxygen vacancies in the surface region of the ceramic envelope were eliminated, which resulted in suppressing the dispersion of the alumina ceramic.

With the above configuration, the metal halide lamp 28 according to the second embodiment can achieve high luminous efficiency, as is the case of the metal halide lamp 1 of the first embodiment. The internal surface of the casing tube 2 is prevented from being colored by the dispersed ceramic, and therefore a decline in the lumen maintenance and a deterioration of quality in appearance, which arise as a result of the coloring, can be prevented. Moreover, the lumen maintenance can be improved.

Note that the second embodiment describes the case in which two oxygen-releasing getters 29 are attached. However, the same operational effectiveness can be accomplished using one or more than two oxygen-releasing getters.

Additionally, in the second embodiment, the oxygen-releasing getters 29 are attached onto the electric power supply wire 8, with one placed nearer the rounded closed end of the casing tube 2 and the other positioned nearer the flare 5. However, the positions for attaching the oxygen-releasing getters 29 are not limited to these, and are determined case by case in view of attachability of the oxygen-releasing getters 29, their influence on the spatial distribution characteristics of luminous intensity, and so on.

In the second embodiment, the oxygen-releasing getters 29 composed of barium peroxide are used. However, the same operational effectiveness can be accomplished by using publicly-known oxygen-releasing getters having a different constituent.

### 3. Third Embodiment

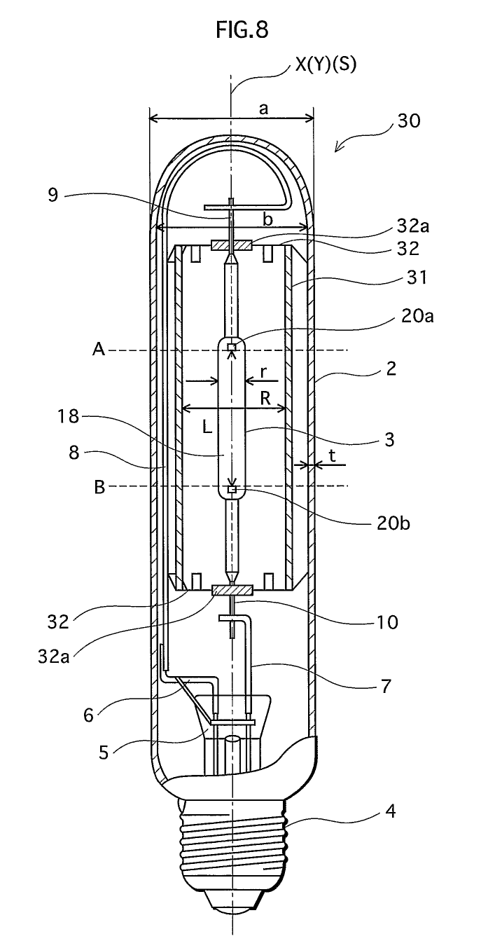

FIG. 8 shows a metal halide lamp 30 according to a third embodiment of the present invention. The metal halide lamp 30 with rated lamp wattage of 150 W has an overall length of 175 mm-185 mm (e.g. 180 mm). In addition to the configuration of the metal halide lamp 1, having rated lamp wattage of 150 W, of the first embodiment, the metal halide lamp 30 has a casing tube 31 and supporting members 32 that support the casing tube 31. The casing tube 31 made of a single-layered sleeve is placed between the outer tube 2 and the arc tube 3, surrounding the entire arc tube 3 (except for parts of the external lead wires 9 and 10 which are led to the outside of the arc tube 3).

As shown in FIG. 8, the arc tube 3, the outer body 2, and the casing tube 31 each have central axes, X, Y, and S, respectively, in the longitudinal direction. These central axes all substantially coincide with one another.

The outer body 2 is a cylindrical tube made of, for example, hard glass or borosilicate glass with an external diameter a of 30 mm-50 mm (e.g. 40 mm) and an internal diameter b of 28.5 mm-48.5 mm (e.g. 38.5 mm). One end of the outer body 2 is closed and round in shape while the other end is closed by fixing thereto a flare 5 made of, for example, borosilicate glass.

Onto the electric power supply wire 8, one or more oxygen-releasing getters are, if required, attached.

The arc tube 3 of the metal halide lamp 30 has the same configuration as the one shown in FIG. 2. The metal halide lamp 30 satisfies a relational expression of R/r≧3.0, where R is the internal diameter of the casing tube 31 and r is the external diameter of the arc tube 3, within a region positionally corresponding to, in a radial direction of the arc tube 3, the space between a pair of electrodes 20a and 20b, on a cross-sectional surface where the outer circumference of the arc tube 3 comes closest to the inner circumference of the casing tube 31.

The “region positionally corresponding to, in a radial direction of the arc tube 3, the space between a pair of electrodes 20a and 20b” means a region sandwiched by two imaginary planes. FIG. 8 illustrates the two imaginary planes indicated with dashed lines A and B. The plane with the dashed line A lies at the tip of the electrode 20a and is perpendicular to the central axis in the longitudinal direction of the electrode 20a. Similarly, the plane with the dashed line B lies at the tip of the other electrode 20b and is perpendicular to the central axis in the longitudinal direction of the electrode 20b.

The arc tube 3 is formed so as to satisfy a relational expression of L/D≧4, where D is the internal diameter of, within the main tube part 18, a portion sandwiched by the two imaginary planes. Here, the bulb wall loading (input lamp power per unit internal surface area of an arc tube) is set at 26 W/cm²-34 W/cm².

The casing tube 31 is made, for example, of quartz glass. The casing tube 31 is provided in order to protect the outer tube 2 from being damaged by broken pieces and such, in the case of breakage of the arc tube 3.

The supporting members 32 made of publicly-known disk-shaped metal plates are placed at open ends of the casing tube 31. Each of the supporting members 32 is fixed onto the external lead wire 9 or 10 with an insulating member 32a. The casing tube 31 is sandwiched by these supporting members 32 at its open ends, and thereby kept in place within the outer tube 2. The entire open ends of the casing tube 31 are substantially covered and thus closed by the metal plates.

Note that the supporting members 32 are not limited to the disk-shaped metal plates, and various publicly-known shaped ones can be used instead. In addition, instead of the disk-shaped metal plates, ring-shaped members (not shown) may be attached to the outer surface of the casing tube 31 at the both open ends. In this case, the casing tube 31 is kept in place by fixing a part of each ring-shaped member onto the electric power supply wire 8.

With the above configuration of the metal halide lamp 30 according to the third embodiment, as is the case with the first embodiment, especially because the relational expression of L/D≧4 is satisfied, the self-absorption ratio of sodium is reduced. Herewith, emission in the wavelength range positively contributing to the luminous efficiency can be increased. Furthermore, high luminous efficiency can be achieved since the vapor pressures of the metal halides are elevated by raising the temperature of the internal surface of the arc tube 3. On the other hand, ample space is provided between the casing tube 31 and the arc tube 3 across the region sandwiched by the imaginary planes (i.e. the region positionally corresponding to, in a radial direction of the arc tube 3, the space between the electrodes 20a and 20b), and thereby the thermal insulation effect of the casing tube 31 exerted on the arc tube 3 is reduced. Accordingly, it can be prevented that the maximum temperature T (K) of the external surface of the arc tube 3 will rise excessively high. This allows for preventing the ceramic forming the envelope of the arc tube 3 from heavily evaporating and dispersing. Consequently, this further prevents the internal surface of the casing tube 31 from being colored by the dispersed ceramic, and therefore a decline in the lumen maintenance as well as a deterioration of quality in appearance, which arise as a result of the coloring, can be prevented.

Note that the third embodiment above describes the case in which the casing tube 31 is placed so as to surround the entire arc tube 3 (except for parts of the external lead wires 9 and 10 which are led to the outside of the arc tube 3). However, the same operational effectiveness can be accomplished when the casing tube 31 surrounds the arc tube 3, at least around a portion sandwiched by the imaginary planes.

In addition, the third embodiment above describes the case in which the entire open ends of the casing tube 31 are substantially blocked by the metal-plate supporting members 32. The present invention is, however, not limited to this case, and the same operational effectiveness above can be accomplished when one of the open end may be substantially fully open, or when the open ends are partially open. That is, the same operational effectiveness described above can be accomplished regardless of the extent of the openness between the internal space and the external space of the casing tube 31.

The third embodiment describes the case in which the casing tube 31 is a single-layered sleeve. The present invention is, however, not limited to this, and the same operational effectiveness may be accomplished by using a multiple-layered sleeve, e.g. a double-layered sleeve, instead.

Although the third embodiment makes no reference to setting positions for oxygen-releasing getters, one or more oxygen-releasing getters may be disposed either outside or inside of the casing tube 31. That is, the oxygen-releasing getters are required only to be disposed in a hermetically-sealed space where the arc tube 3 is housed (in the third embodiment, this corresponds to the space inside of the outer tube). Thus, whether a sleeve is provided in the space is irrelevant to the decision of setting positions of the getters. Note that, when oxygen-releasing getters are disposed inside the casing tube 31, supporting members may be required in order to support these getters.

The above first to third embodiments all describe the cases in which the metal halides enclosed in the arc tube 3 are praseodymium iodide and sodium iodide. However, the same operational effectiveness can also be accomplished in any of the following cases: when cerium iodide is used instead of the praseodymium iodide; when cerium iodide is used in addition to the praseodymium iodide; and when bromide and such are used instead of the iodides.

The above first to third embodiments all describe the cases in which the metal halides enclosed in the arc tube 3 are praseodymium iodide and sodium iodide. In addition to these metal halides, however, a publicly-known metal halide may be added in order to obtain particular lamp characteristics, such as desired color rendering.

The above first to third embodiments all exemplify the metal halide lamps having rated lamp wattage of 150 W. The present invention is, however, not confined to these lamps, and the same operational effectiveness above can be accomplished when the present invention is applied to metal halide lamps having rated lamp wattage ranging, for example, from 20 W to 400 W.

The above first to third embodiments all exemplify the arc tube 3 whose main tube part 18 is circular cylindrical. However, the present invention is not confined to this shape, and the same operational effectiveness above can be accomplished when the main tube part 18 has a publicly-known shape such as a substantially ellipsoidal shape, or a generally conceivable and usable shape. As a matter of course, when the arc tube 3 takes a publicly-known shape or a generally conceivable and usable shape, the same operational effectiveness above can also be accomplished.

The above first to third embodiments all exemplify the casing tubes 2 and 31 each having a circular cylindrical shape. However, the present invention is not confined to this, and the same operational effectiveness above can be accomplished when the casing tubes take a publicly-known shape or a generally conceivable and usable shape. As a matter of course, the same operational effectiveness above can be accomplished by a combination of one of the various shaped casing tubes and one of the various shaped arc tubes mentioned above.

### 4. Fourth Embodiment

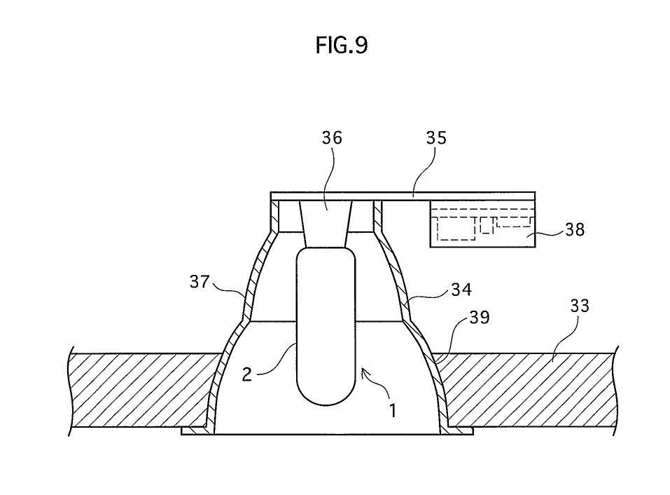

FIG. 9 shows a luminaire according to a fourth embodiment of the present invention. The luminaire is used, for instance, for ceiling lighting, and comprises a main lighting body 37, the metal halide lamp 1 (rated lamp wattage: 150 W) of the first embodiment, and a lighting circuit 38. The main lighting body 37 is composed of a reflector 34, a base unit 35, and a socket 36. The reflector 34 has an umbrella shape, and is set in a ceiling 33. The base unit 35 has a plate-like shape, and is attached to the bottom plane of the reflector 34. The socket 36 is placed on this bottom plane within the reflector 34. Within the main lighting body 37, the metal halide lamp 1 is attached to the socket 36. The lighting circuit 38 is placed, on the base unit 35, at a position apart from the reflector 34.

Note that a shape and such of a reflection surface 39 of the reflector 34 are determined case by case in view of the applications and use conditions of the luminaire.

The lighting circuit 38 uses a publicly-known electronic ballast. In the case where a commonly-used magnetic ballast is employed as a ballast, the lamp electric power fluctuates as a result of fluctuations in the power supply voltage. When the supply voltage becomes high, the lamp electric power may exceed the rated electric power and thereby the external surface of the arc tube (not shown) may reach a high temperature. Accordingly, there is a possibility that the ceramic forming the envelope of the arc tube would evaporate and disperse. On the other hand, in the case where the electronic ballast is used, the lamp electric power is kept at constant in a vast range of voltage. This allows for controlling the temperature of the external surface of the arc tube to be at constant, and thereby the possibility that the ceramic would evaporate and disperse can be reduced.

As described above, the configuration of the luminaire according to the fourth embodiment prevents the ceramic forming the envelope of the arc tube from heavily evaporating and dispersing since the metal halide lamp 1 of the first embodiment above is used. Herewith, it is prevented that the internal surface of the casing tube will be colored by the dispersed ceramic, and therefore a decline in the lumen maintenance and a deterioration of quality in appearance, which arise as a result of the coloring, can also be prevented.

In particular since an electronic ballast is used as a ballast of the lighting circuit 38, the external surface of the arc tube can be controlled at a constant temperature. As a result, the possibility that the ceramic forming the envelope of the arc tube would evaporate and disperse can certainly be reduced.

Note that the fourth embodiment exemplifies a case in which the luminaire is used for ceiling lighting. However, the present invention is not confined to this use, and can also be applied to other types of interior lighting, store lighting, and street lighting. In addition, the luminaire of the present invention can adopt a variety of publicly-known main lighting bodies and lighting circuits according to the uses.

The fourth embodiment describes the case in which the metal halide lamp 1 of the first embodiment is used. However, the same operational effectiveness above can be accomplished by using any of the metal halide lamps according to the above embodiments.

### INDUSTRIAL APPLICABILITY

The metal halide lamp and the luminaire using the same of the present invention are applicable to situations where it is necessary to prevent a decline in the lumen maintenance and a deterioration of quality in appearance of the metal halide lamp, which arise as a result of the coloring in the casing tube (e.g. an outer tube and a sleeve) surrounding the arc tube, as well as to achieve high luminous efficiency at the same time.

1. A metal halide lamp comprising:
an arc tube having an envelope made of translucent ceramic, a pair of electrodes disposed therein, and one or more halides are enclosed therein; and
a casing tube surrounding at least a portion of the arc tube, the portion positionally corresponding to, in a radial direction of the arc tube, a space between the electrodes, wherein
L/D≧4, where L is a length of the space between the electrodes and D is an internal diameter of the arc tube, and
R/r≧3.0, where R is an internal diameter of the casing tube and r is an external diameter of the arc tube, within a region positionally corresponding to, in the radial direction, the space between the electrodes, on a cross-sectional surface where an outer circumference of the arc tube comes closest to an inner circumference of the casing tube.

2. The metal halide lamp of claim 1, wherein
4.7≦R/r≦8.0.

3. The metal halide lamp of claim 1, wherein
4≦L/D≦10.

4. The metal halide lamp of claim 2, wherein
4≦L/D≦10.

5. The metal halide lamp of claim 1, wherein
the arc tube is disposed in a hermetically-sealed space, and
a degree of vacuum in the space is no more than 1×10¹ Pa at 300 K.

6. The metal halide lamp of claim 4, wherein
the arc tube is disposed in a hermetically-sealed space, and
a degree of vacuum in the space is no more than 1×10¹ Pa at 300 K.

7. The metal halide lamp of claim 5, wherein
one or more oxygen-releasing getters are disposed in the space.

8. The metal halide lamp of claim 6, wherein
one ore more oxygen-releasing getters are disposed in the space.

9. The metal halide lamp of claim 1, wherein
the halides include sodium.

10. The metal halide lamp of claim 8, wherein
the halides include sodium.

11. A luminaire comprising:
a metal halide lamp recited in claim 1; and
a lighting circuit for illuminating the metal halide lamp.
